(19) United States
(12) Patent Application Publication
(10) Pub. No.: US 2008/0282240 A1
(43) Pub. Date: Nov. 13, 2008

(54) Backup method for portable terminal apparatus

(75) Inventor: Feng-Wei Hsu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/798,143

(22) Filed: May 10, 2007

(51) Int. Cl. G06F 9/44

(52) U.S. Cl. 717/170

(57) ABSTRACT

A backup method for a portable terminal apparatus includes the following steps. Firstly, a program folder is searched to get a filename of at least one shortcut file corresponding to software. Next, the backup method is to judge whether the shortcut file is up-to-date or not, and to judge whether an uninstall file corresponding to the software exists or not when the shortcut file is up-to-date. Then, software data and a registry key value corresponding to the software are retrieved according to the uninstall file when the uninstall file exists. After that, the software data and the registry key value are recorded to at least one data variation table. Finally, a backup operation is conducted according to the data variation table. Thus, the backup method allows the user to select up-to-date software and conduct backup operations dynamically.

### BACKGROUND OF THE INVENTION

1. Field of Invention

The invention relates to a backup method, and, in particular, to a backup method for a portable terminal apparatus.

2. Related Art

With advancing technology, everyday electronic products developed rapidly. More particularly, portable terminal apparatuses, such as notebook computers, smart mobile phones or personal digital assistants (PDAs) facilitate our daily business, and enhance our lives in numerous ways.

When these portable terminal apparatuses are used, they often require file backup. For example, file backup must be conducted before the new software is installed in order to prevent the irrecoverable error from occurring as the new software is installed. Alternatively, contemporary PDAs may lose some files if they are shut down too long. Thus, PDAs must often conduct file backup operations. Furthermore, such electronic products are frequently upgraded. When the user wants to upgrade the product but does not want to waste time in installing software, he or she may conduct file backup first, and then conduct a recovery process according to the backup file.

In general, when the user is installing new software or is conducting a software upgrade, installation files may be created, and some registry key values may be created in a system registry table so that the software can access the registry key values afterwards. The difficulty of smart software backup resides in the content variation of registry key values and installation file paths, which are not easily managed. The contemporary backup program only provides some default options to be selected by the user for file backup, wherein the default options may be, for example, my documents, short messages, telephone numbers, data books, or the like. The contemporary backup programs fail to provide backup options for installed software or upgraded portions of the software dynamically, thereby limiting the efficiency of subsequent backup operations.

### SUMMARY OF THE INVENTION

In view of the foregoing, the invention is to provide a backup method for a portable terminal apparatus capable of immediately obtaining up-to-date data and an up-to-date registry key value of software and allowing a user to dynamically select installed and upgraded software and to conduct a backup operation.

To achieve the above, the invention, discloses a backup method for a portable terminal apparatus. The method includes the steps of: searching a program folder to get a filename of at least one shortcut file corresponding to software; judging whether the shortcut file is up-to-date or not; judging whether an uninstall file corresponding to the software exists or not when the shortcut file is up-to-date; retrieving the software data and a registry key value corresponding to the software according to the uninstall file if the uninstall file exists; recording the software data and the registry key value to at least one data variation table; and conducting a backup operation according to the data variation table.

The invention judges whether up-to-date software, which is the new or upgraded software installed by the user, exists or not according to the shortcut file, and then retrieves the uninstall file corresponding to the software. Then, the software data and the registry key value from installation or upgrade may be retrieved according to the uninstall file, and thus the software data and the registry key value may then be recorded. Consequently, the software installed or upgraded by the user can be dynamically selected by the user according to the recorded software data and the recorded registry key value, and the backup may be conducted.

### BRIEF DESCRIPTION OF THE DRAWINGS

The invention will become more fully understood from the detailed description given herein below illustration only, and thus is not limitative of the present invention, and wherein:

FIG. 1 is a flow chart showing a backup method for a portable terminal apparatus according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

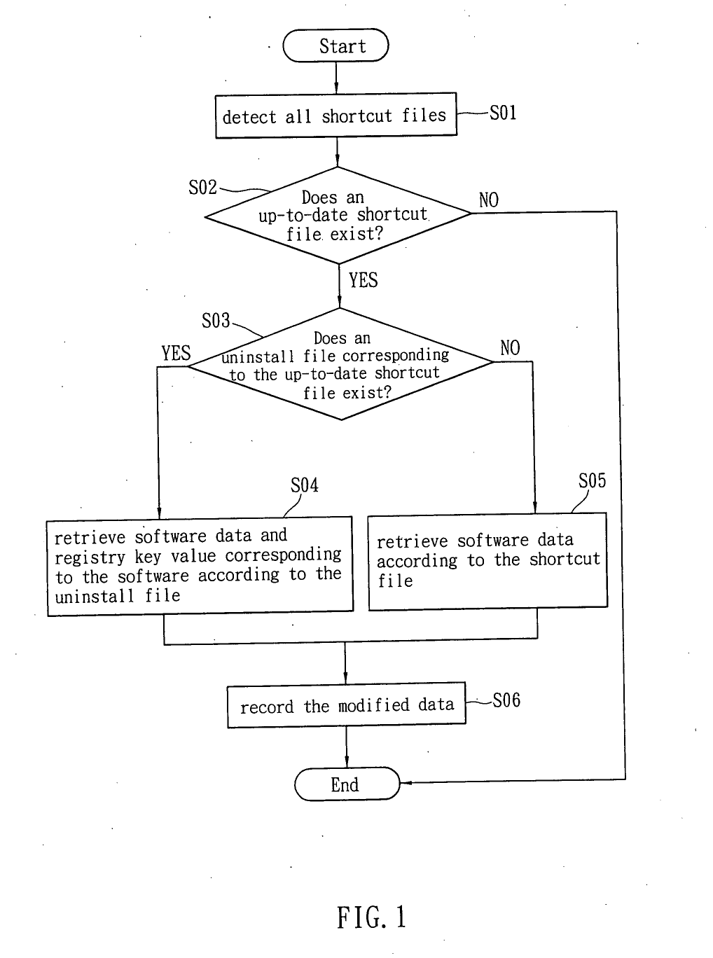

FIG. 1 is a flow chart showing a backup method for a portable terminal apparatus according to a preferred embodiment of the invention. In this embodiment, the portable terminal apparatus may be a mobile communication device, such as a smart mobile phone, a personal digital assistant, or a notebook computer.

First, in step S01, the backup method of this embodiment detects all shortcut files, wherein each shortcut file corresponds to one kind of software. In general, all the shortcut files are usually found in the same data folder, such as the program folder with the path of “Windows\Start Menu\Program”, for example, in one operation system. This step is performed in order to judge which software has been installed by the user. After the shortcut file is found, the filename thereof may be recorded. In this embodiment, the filenames of the shortcut files are recorded into a file variation table so that the shortcut files can be used subsequently.

Next, in step S02, the backup method of this embodiment judges whether an up-to-date shortcut file exists or not. Herein, the software corresponding to the up-to-date shortcut file includes the new software installed by the user, and an upgraded portion for the installed software. In this embodiment, it is possible to conduct the operation of judging whether the up-to-date shortcut file exists or not according to the filename of the shortcut file. For example, it is possible to compare the filenames of all the detected shortcut files with the filenames recorded in the file variation table so as to know which shortcut files are up-to-date. Of course, if the backup method of this embodiment is executed in the portable terminal apparatus initially, all the detected shortcut files will be up-to-date.

In this step, it is also possible to perform the judgment according to another attribute, such as the file modification time of the shortcut file. In practice, the file modification time of each of the detected shortcut files may be recorded into the file variation table, and then the file modification time of each of the detected shortcut files is compared with each file modification time recorded in the file variation table. Thus, it is possible to know which shortcut files are newly added after the backup method of this embodiment is performed.

Next, as shown in step S03, when the up-to-date shortcut file exists, the backup method of this embodiment judges whether an uninstall file corresponding to the up-to-date shortcut file exists or not. Because the uninstall file records which data is added in the updating process (including the installation of the new software and the upgrade of the software). The up-to-date data includes the program file of the software and a registry key value existing in a system registry table. Paths of the up-to-date data are recorded in the uninstall file. So, before the up-to-date data is retrieved, it is necessary to judge whether the uninstall file of the software corresponding to the up-to-date shortcut file exists or not.

In this step, the backup method of this embodiment is performed according to whether the uninstall file corresponding to the software exists in the system registry table or not. Because the system registry table records the path of the uninstall file, the backup method of this embodiment performs a search in the system registry table according to the filename of the up-to-date shortcut file. When the software corresponding to the up-to-date shortcut file has the uninstall file, the path of the uninstall file may be retrieved.

When the uninstall file is judged to exist, the backup method of this embodiment may conduct step S04 to retrieve the software data and the registry key value corresponding to the software according to the uninstall file. The software data includes a filename and a file path of at least one of the program files contained in the software.

With regard to the software data, the uninstall file has recorded the program file and the path of the software. So, when the path of the uninstall file is retrieved, the uninstall file may be read to get the path and the filename of the program file contained in the software. With regard to the registry key value, the uninstall file has recorded the modified register code, so the corresponding registry key value may be retrieved from the system registry table according to the register code.

When the uninstall file corresponding to the shortcut file is judged not to exist, the backup method of this embodiment conducts step S05 to retrieve the software data according to the shortcut file. Herein, the software data includes the filename and the file path of at least one of the program files contained in the software. Because most software files without uninstall files are independent executable files, the extension name may be “exe”, “bat”, “corn” and the like. In addition, some software, such as executable files and some program files with the extension names of “dll”, “ini” and the like, may also have no uninstall file, and these program files have to be all recorded so that the subsequent backup operation can be conducted. In summary, the path of the program file can be directly retrieved according to the shortcut file of the software without the uninstall file so that the software corresponding to the shortcut file may be retrieved according to the path.

After the modified data such as the software data with and without the uninstall file and registry key value are retrieved, the data can be recorded (step S06). In this embodiment, the retrieved modified data is recorded into the file variation table. Consequently, the user may subsequently conduct the backup operation according to the file variation table. In addition, in order to facilitate the backup operation conducted by the user, the step of conducting the backup operation according to a data variation table may include adding the filename of the shortcut file to a backup menu, displaying the backup menu, receiving a selection signal corresponding to the backup menu, and conducting the backup operation according to the selection signal. That is, the backup menu, on which all filenames of the up-to-date software are displayed, is displayed and the user selects the backup software and conducts the backup operation.

It is to be noted that the backup method of this embodiment may be automatically executed when the user is adding the software, that is, when the user is installing the new software or conducting the software upgrading procedure, so that the efficiency of use may be enhanced. Of course, the user may also manually enable the backup method.

In summary, the backup method for the portable terminal apparatus of the invention judges whether the up-to-date software, which is the new or upgraded software added by the user, exists or not according to the shortcut file. The uninstall file corresponding to the software is then retrieved. Thus, the software data and the registry key value after the user has installed or upgraded the software are retrieved according to the uninstall file, and then the software data and the registry key value are recorded. Thus, the software installed by the user or upgraded by the user may be selected by the user dynamically so that the backup process may be conducted.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A backup method for a portable terminal apparatus, the method comprising:
searching a program folder to get a filename of at least one shortcut file, the shortcut file corresponding to software;
judging whether the shortcut file is up-to-date or not;
judging whether an uninstall file corresponding to the software exists or not when the shortcut file is up-to-date;
retrieving software data and a registry key value corresponding to the software according to the uninstall file when the uninstall file exists;
recording the software data and the registry key value to at least one data variation table; and
conducting a backup operation according to the data variation table.

2. The method according to claim 1, further comprising:
recording the filename of the shortcut file.

3. The method according to claim 1, further comprising:
recording a file modification time of the shortcut file.

4. The method according to claim 1, wherein the software data comprises a filename and a file path of at least one of program files contained in the software.

5. The method according to claim 1, wherein the step of judging whether the shortcut file is up-to-date or not is conducted according to the filename of the shortcut file or a file modification time of the shortcut file.

6. The method according to claim 1, wherein the step of judging whether the uninstall file corresponding to the software exists or not is conducted according to a system registry table.

7. The method according to claim 1, wherein the step of retrieving the software data according to the uninstall file comprises:
retrieving a path of the uninstall file through a system registry table; and
reading the uninstall file to get a path of a program file contained in the software.

8. The method according to claim 1, wherein the registry key value is retrieved from a system registry table in the step of retrieving the registry key value corresponding to the software according to the uninstall file.

9. The method according to claim 1, wherein the step of conducting the backup operation according to the data variation table comprises:
adding the filename of the shortcut file to a backup menu and displaying the backup menu;
receiving a selection signal corresponding to the backup menu; and
conducting the backup operation according to the selection signal.

10. The method according to claim 1, further comprising:
retrieving the software data according to the shortcut file when the uninstall file does not exist.

11. The method according to claim 10, further comprising:
recording the software data.

12. The method according to claim 10, wherein the software data comprises a filename and a file path of at least one of program files contained in the software.

13. The method according to claim 12, wherein the program file is an executable file.
